(19) United States
(12) Patent Application Publication
(10) Pub. No.: US 2009/0147751 A1
(43) Pub. Date: Jun. 11, 2009

(54) METHOD OF APPLYING FAST MOBILE IPV6 FOR MOBILE NODES IN MOBILE NETWORKS, MOBILE ROUTER THEREFOR, AND MOBILE NETWORK THEREFOR

(76) Inventors: Lakshmi Prabha Gurusamy, Bangalore (IN); Sameer Kumar, Bangalore (IN); Ranjitsinh Udaysinh Wable, Bangalore (IN); Kishore Mundra, Bangalore (IN); Syam Madanapalli, Bangalore (IN)

Correspondence Address: STEIN MCEWEN, LLP, 1400 EYE STREET, NW, SUITE 300, WASHINGTON, DC, 20005, US

(21) Appl. No.: 11/997,961

(22) PCT Filed: Aug. 4, 2006
(86) PCT No.: PCT/KR06/03084

§ 371 Date: Sep. 10, 2008

(30) Foreign Application Priority Data
Aug. 5, 2005 (IN) 1068/CHE/2005

(51) Int. Cl. H04W 36/00

(52) U.S. Cl. 370/331

(57) ABSTRACT

Provided are a method of applying fast mobile IPv6 (FMIPv6) to a mobile node in order to prevent loss of packets transmitted during a handover of a mobile router from a first access router to a second access router, and a mobile router and a mobile network therefor. Specifically, the mobile router receives, from the first access router, a message containing a prefix corresponding to the second access router, transmits, to the mobile node, a message containing the prefix and information indicating that the prefix is received from the first access router, transmits, to the first access router, a message for FMIPv6, and transmits, to the mobile node, a message to set a zero lifetime for a prefix corresponding to the first access router. Furthermore, the mobile node transmits a message for FMIPv6 to the first access router when the mobile node receives the message containing the prefix.

### CROSS-REFERENCE TO RELATED APPLICATIONS

This application is a National Stage of PCT International Patent Application No. PCT/KR2006/003084, filed Aug. 4, 2006, and claims the benefit of Indian Patent Application No. 1068/CHE/2005, filed Aug. 5, 2005, in the Indian Intellectual Property Office, the disclosures of which are incorporated herein by reference.

### BACKGROUND OF THE INVENTION

1. Field of the Invention

Aspects of the present invention relate to mobile IPv6 (MIPv6), and more particularly, to a method of applying fast MIPv6 (FMIPv6) to a mobile node while a mobile router performs a handover, and a mobile router and a mobile network therefor.

Aspects of the present invention also relate to a method of optimizing a neighbor discovery (ND) proxy-based route, and applying FMIPv6, for a mobile node in a mobile network.

2. Description of the Related Art

A technology of optimizing a route by using a neighbor discovery (ND) proxy delegates a network prefix for each mobile node (MN) in a mobile network by a mobile router (MR). Prefix delegation is a process of transferring a prefix to a mobile node in order to generate an IPv6 address. Each mobile node sets a Care of Address (CoA) from its delegated prefix in order to perform route optimization (RO).

In fast mobile IPv6 (FMIPv6), a CoA is generated and bound while a handover is performed at a link level. Various methods of applying FMIPv6 for a mobile router have been introduced. For example, Korean Laid-Open Patent Publication No. 10-2005-0039066 discloses a route optimization method for mobile nodes in an IPv6 mobile network on a basis of neighbor discovery proxy.

A mobile router (MR) can perform FMIPv6, thereby preventing packets from being lost by a corresponding node (CN). However, since a mobile node (MN) establishes communications via the MR, a handover does not occur at a link level, even if a mobile network is moved. Thus, packets transmitted to a previous CoA of the MN are likely to be lost while the MR performs the handover. Therefore, the MR must perform FMIPv6 during the handover. However, no technology has been available for a MR to undertake FMIPv6 in a mobile network node in order to prevent loss of packets.

### SUMMARY OF THE INVENTION

Aspects of the present invention are designed to prevent loss of packets transmitted to a mobile node during a mobile router's handover. In particular, aspects of the present invention provide a method of applying FMIPv6 to a mobile node in order to prevent loss of packets transmitted to the mobile node during a mobile router's a handover, and a mobile router and a mobile network therefor. Aspects of the present invention also provide a computer readable medium having recorded thereon a computer program for the method of applying FMIPv6 to a mobile node.

Accordingly, aspects of the present invention provide a method that prevents loss of packets for an on-going session between MNNs and CNs when the MR undergoes handover, reduces hand-off latency for MNNs, requires no re-configuration or support of v6 routers, is interoperable with existing standards, and is simple and easily deployable.

According to an aspect of the present invention, there is provided a method of applying fast mobile IPv6 (FMIPv6) to a mobile node in a mobile network when a mobile router of the mobile network performs a handover from a first access router to a second access router, the method including: receiving, by the mobile router, a message from the first access router including a prefix corresponding to the second access router; transmitting, from the mobile router to the mobile node, a message including the prefix corresponding to the second access router and information indicating that the prefix is received from the first access router; transmitting, from the mobile router to the first access router, a message for FMIPv6; transmitting, from the mobile node to the first access router, a message for FMIPv6 when the mobile node receives the message including the information indicating that the prefix is received from the first access router; and transmitting, from the mobile router to the mobile node after the handover, a message to set a zero lifetime for a prefix corresponding to the first access router.

According to another aspect of the present invention, there is provided a mobile router of a mobile network in which fast mobile IPv6 (FMIPv6) is applied to a mobile node when the mobile router performs a handover from a first access router to a second access router, the mobile router including: a message receiving unit to receive, from the first access router, a message including a prefix corresponding to the second access router; and a message transmitting unit to transmit a message, to the mobile node, including the prefix corresponding to the second access router and information indicating that the prefix is received from the first access router, a message, to the first access router, for FMIPv6, and a message, to the mobile node after the handover, to set a zero lifetime for a prefix corresponding to the first access router, wherein the mobile node transmits a message for FMIPv6 to the first access router when the mobile node receives the message including the information indicating that the prefix is received from the first access router.

According to yet another aspect of the present invention, there is provided a mobile network in which fast mobile IPv6 (FMIPv6) is applied to a mobile node, the mobile network including: a mobile router to perform a handover from a first access router to a second access router, to receive, from the first access router, a message including a prefix corresponding to the second access router, to transmit, to the mobile node, a message including a prefix corresponding to the second access router and information indicating that the prefix is received from the first access router, to transmit, to the first access router, a message for FMIPv6, and to transmit, to the mobile node after the handover, a message to set a zero lifetime for a prefix corresponding to the first access router; and the mobile node to transmit, to the first access router, a message for FMIPv6 when the mobile node receives the message including the information indicating that the prefix is received from the first access router.

According to still another aspect of the present invention, there is provided a computer-readable medium having recorded thereon a computer program for a method of applying fast mobile IPv6 (FMIPv6) to a mobile node in a mobile network when a mobile router of the mobile network performs a handover from a first access router to a second access router, the method including: receiving, by the mobile router, a message from the first access router including a prefix corresponding to the second access router; transmitting, from the mobile router to the mobile node, a message including the prefix corresponding to the second access router and information indicating that the prefix is received from the first access router; transmitting, from the mobile router to the first access router, a message for FMIPv6; transmitting, from the mobile node to the first access router, a message for FMIPv6 when the mobile node receives the message including the information indicating that the prefix is received from the first access router; and transmitting, from the mobile router to the mobile node after the handover, a message to set a zero lifetime for a prefix corresponding to the first access router.

According to another aspect of the present invention, there is provided a mobile node applying fast mobile IPv6 (FMIPv6) in a mobile network when a mobile router of the mobile network performs a handover from a first access router to a second access router, the mobile node including: a message receiving unit to receive a message including a prefix corresponding to the second access router and information indicating that the prefix is received from the first access router; and a message transmitting unit to transmit a message for FMIPv6 to the first access router when the mobile node receives the message indicating that the prefix is received from the first access router, wherein the mobile router receives, from the first access router, a message including the prefix corresponding to the second access router, transmits, to the mobile node, the message including the prefix corresponding to the second access router and information indicating that the prefix is received from the first access router, transmits, to the first access router, a message for FMIPv6, and transmits to the mobile node after the handover a message to set a zero lifetime for a prefix corresponding to the first access router.

According to another aspect of the present invention, there is provided a method of applying fast mobile IPv6 (FMIPv6) to a mobile node in a mobile network when a mobile router of the mobile network performs a handover from a first access router to a second access router, the method including: receiving, by the mobile router, a message from the first access router including a prefix corresponding to the second access router; transmitting, from the mobile router to the mobile node, a message including the prefix corresponding to the second access router and an indication that FMIPv6 can be performed; transmitting, from the mobile router to the first access router, a message for FMIPv6; and transmitting, from the mobile node to the first access router, a message for FMIPv6 when the mobile node receives the message including the indication that FMIPv6 can be performed.

According to still another aspect of the present invention, there is provided a method of a mobile node applying fast mobile IPv6 (FMIPv6) in a mobile network when a mobile router of the mobile network performs a handover from a first access router to a second access router, the method including: receiving, from the mobile router, a message including a prefix corresponding to the second access router and information indicating that the prefix is received from the first access router; transmitting, to the first access router, a message for FMIPv6 after receiving the message including the information indicating that the prefix is received from the first access router; and receiving, from the mobile router after the handover, a message to set a zero lifetime for a prefix corresponding to the first access router.

According to yet another aspect of the present invention, there is provided a method of a mobile router of a mobile network applying fast mobile IPv6 (FMIPv6) to a mobile node in the mobile network when the mobile router performs a handover from a first access router to a second access router, the method including: receiving a message from the first access router including a prefix corresponding to the second access router; transmitting, to the mobile node, a message including the received prefix corresponding to the second access router and information indicating that the prefix is received from the first access router; transmitting, to the first access router, a message for FMIPv6; and transmitting, to the mobile node after the handover, a message to set a zero lifetime for a prefix corresponding to the first access router.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a routing path in a mobile network;

FIG. 2 is a block diagram illustrating an example of a routing path when performing route optimization in a mobile network;

FIG. 3 is a block diagram illustrating another example of a routing path when performing route optimization in a mobile network;

FIG. 4 illustrates an IPv6 network to which aspects of the present invention are applied;

FIG. 5 illustrates a general prefix information option in a router advertisement message;

FIG. 6 illustrates a prefix information option having an ‘H’ flag according to an embodiment of the present invention; and

FIG. 7 is a timing diagram of a method of applying FMIPv6 according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

While Network Mobility (NEMO) is an emerging field, the Basic NEMO protocol doesn't include route optimization for mobile network nodes (MMN). Therefore, many solutions have been suggested for route optimization in NEMO. According to these route optimization techniques, however, the MNNs may loose packets in their on-going sessions when a mobile router (MR) undergoes a handover. This loss of packets is undesirable.

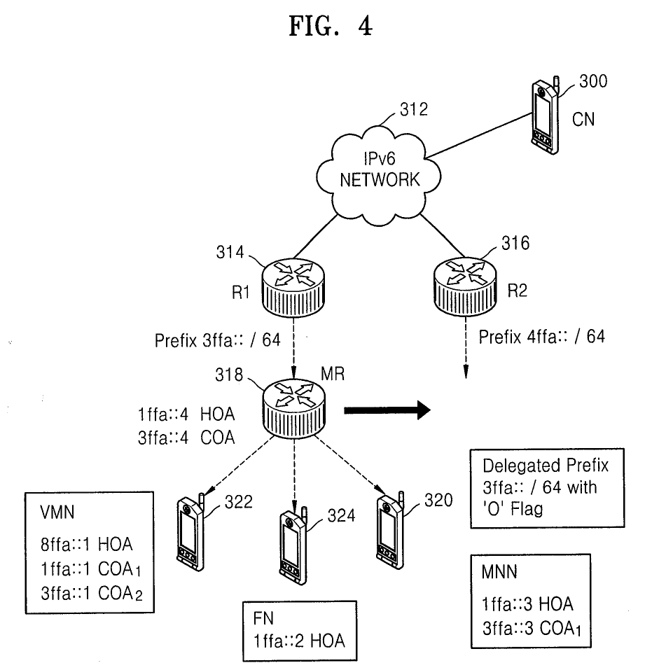

Accordingly, aspects of the present invention avoid a packet loss in an existing communication between an MNN and a corresponding node (CN) while an MR undergoes a handover. In particular, aspects of the present invention add a new flag in a prefix information option of a router advertisement (RA) message, and trigger Fast Mobile Internet Protocol version 6 (FMIPv6) messages by the MNNs without any actual handover occurring when the MMNs receive the prefix information with the new flag. The MR sends the new flag in the prefix information when the MR receives a proxy router advertisement (PrRtAdv). It is assumed that route optimization based on neighbor discovery (ND)-Proxy is working, and the MR, the MNNs and the access routers (R1 and R2 in FIG. 4) are capable of FMIPv6.

In accordance with Mobile Internet Protocol version 6 (MIPv6), a mobile internet protocol (IP) is generally used to maintain a connection of a transfer layer or an upper layer thereof to the Internet, even during movement of a terminal. In the case of a mobile network, an MR, and not a mobile terminal (hereinafter referred to as a mobile node (MN)), is a unit of movement, and a plurality of MNs may be present in a subnet of the MR. When an existing mobile IP is applied to a mobile network, there is no problem with transmission of data from a CN to the MR, but it is impossible to detect a route via which the data is transmitted to sub mobile nodes in the mobile network. MIPv6-based networking technology supports seamless networking of a communication terminal in a transportation unit (such as a bus, a train, or an airplane), which moves in group units, with the Internet.

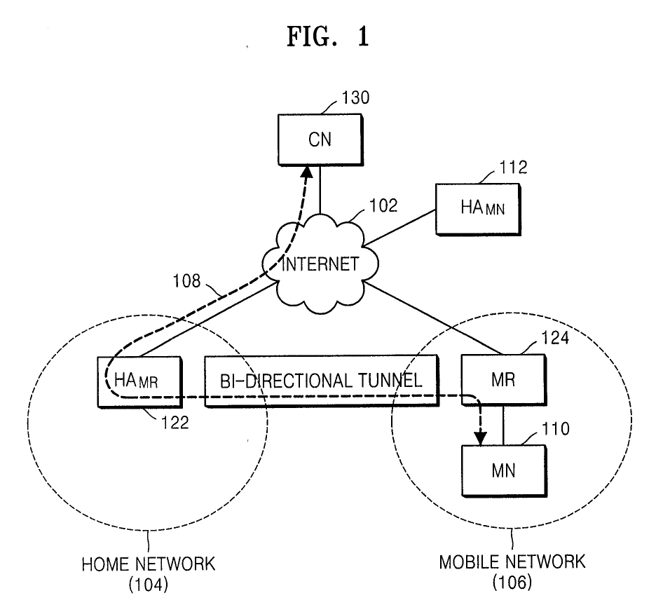

FIG. 1 is a block diagram illustrating a routing path in a mobile network. Referring to FIG. 1, an MN 110 including a fixed node or a mobile node located in a mobile network 106 establishes communication with the Internet 102 via a bidirectional tunnel between an MR 124 controlling mobile networking and a home agent HA_{MR} 122 of the mobile router 124.

A CN 130 connected to the Internet 102 accesses the home address HOA of the MN 110 to establish a communication with the MN 110 in the mobile network 106. The home address of the mobile network 106 to which the MN 110 belongs is bound as a Care of Address (CoA) of the MN 110 in a home agent HA_{MN} 112 of the MN 110. Accordingly, the CN 130 transmits a data packet to the home address HOA of the mobile network 106 to which the MN 110 belongs.

In this case, when the mobile network 106 of a receiving node is not connected to the home network 104 but is connected to a location that is distant from the home network 104, the home agent MA_{MR} 122 of the MR 124 encapsulates the data packet of the CN 130 into a packet having, as a target address, a CoA of the mobile router MR 124 controlling a prefix of the mobile network 106 of a target node (i.e., the MN 110), and transmits the data packet via a bi-directional tunnel between the home agent MA_{MR} 122 and the MR 124.

When receiving the tunneled data packet, the MR 124 decapsulates the data packet, and transmits the decapsulated result to a link where the MN 110 is located. As illustrated in FIG. 1, a route 108 is set between the CN 130 and the MN 110. Thus, the farther the mobile network 106 is located from the home network 104, the greater a transmission delay due to tunneling, which is referred to as a triangle routing problem.

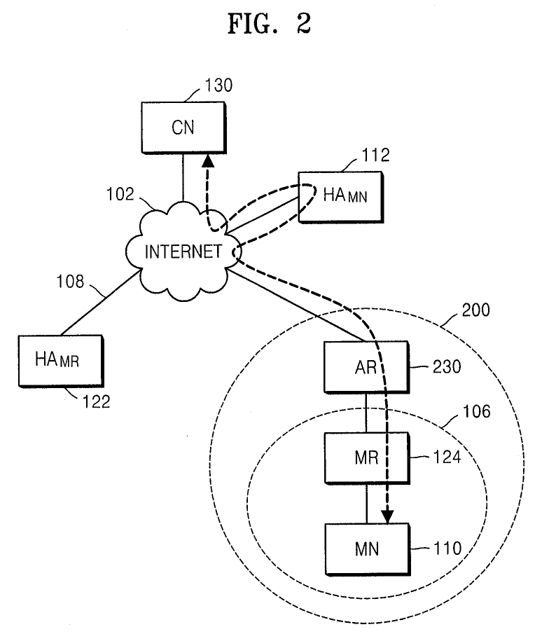

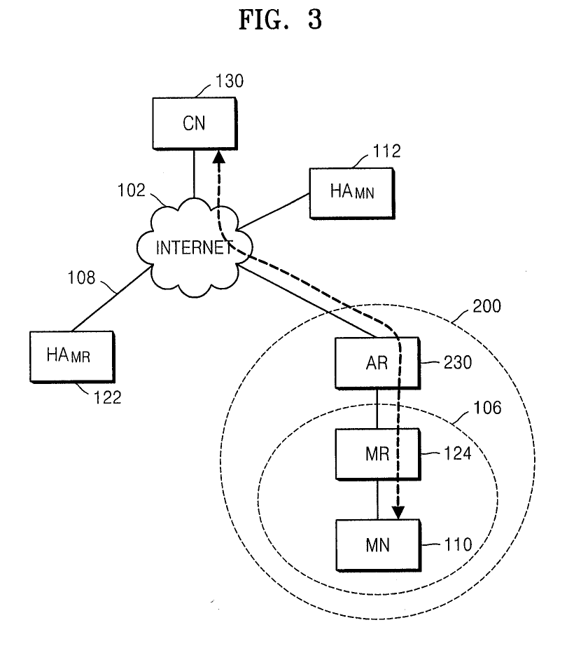

To solve this problem, route optimization is performed with respect to an MN 110. Route optimization is a process in which the MN 110 provides its CoA to the home agent HA_{MN} 112 of the MN 110 or the CN 130 so that a further communication can be established directly by using the CoA. FIG. 2 is a block diagram illustrating a route when route optimization is performed after an MN 110 provides its CoA to a home agent HA_{MN} 122. FIG. 3 is a block diagram illustrating a route when route optimization is performed after an MN 110 provides its CoA to a corresponding node CN 130.

Binding is a process in which the MN 110 provides the home agent HA_{MN} 112 (or the CN 130) with its CoA, and the home agent HA_{MN} 122 (or the CN 130) matches the CoA with the home address HOA of the MN 110. Binding updating (BU) is a process in which the MN 110 having a new CoA provides the new CoA to the home agent HA_{MN} 112 (or the CN 130), and the home agent HA_{MN} 112 (or the CN 130) updates a previous CoA with the new CoA. After a BU is performed with respect to a home address and a CoA, a data packet is transmitted via an optimized route (as illustrated in FIGS. 2 or 3) for a further communication.

MIPv6 is a mobile protocol that further includes a neighbor discovery protocol, automatic address setting, and routing optimization, which are newly defined based on an MIPv4 concept related to a home agent (HA), a home network, an external network, a CoA, etc. In the neighbor discovery protocol, an MR acts as a neighbor discovery proxy.

FIG. 4 shows an IPv6 network 312. Access routers R1 314 and R2 316 are attached to the IPv6 cloud 312 according to an aspect of the present invention. Furthermore, the MR 318 is a mobile router that has mobile network nodes (MNN) 320, visiting mobile nodes (VMN) 322, and fixed nodes (FN) 324 as its network nodes. The MR 318 and the MNNs 320 communicate with a CN 300 attached to the IPv6 Network. Prefixes (3ffa::/64) and (4ffa::/64) have been chosen for R1's network and R2's network, respectively. The MR 318 delegates R1's prefix to network nodes 320, 322, and 324 of the MR 318. As shown, the nodes 320, 322, 324, and 300 are mobile phones and/or personal digital assistants, but aspects of the present invention are not limited thereto.

FIG. 4 depicts a handover of the MR 318 (along with the MNN 320) from R1 314 to R2 316. Referring to FIG. 4, the MR 318 receives beacons from R2 316. Assuming the MR 318 is capable of performing a fast handover, after receiving the beacons, the MR 318 sends a Router Solicitation for Proxy Advertisement (RtSolPr) to R1 314 requesting prefix information regarding R2 316. In response, R1 314 sends a Proxy Router Advertisement (PrRtAdv) to the MR 318. Then, the MR 318 sends a fast binding update (FBU) to R1 314, and R1 314 sends a fast binding acknowledgement (FBAck) to the MR 318. The MR 318 takes the new CoA (4ffa::4) and then switches to R2 316. A bi-directional tunnel is thus established between R1 314 and the MR 318, and all packets destined to MR's previous CoA (3ffa::4) will accordingly be tunneled by R1 314 to the MR 318. Hence, the MR 318 won't loose packets coming from the CN 300 during the handover.

After the handover, the MR 318 sends a zero lifetime setting for the earlier prefix (3ffa::/64) and delegates the new prefix (4ffa::/64). The MNN 320 and the VMN 322 will delete their previous CoAs (i.e., 3ffa::/64) and form new CoAs (i.e., 4ffa::/64) based on the new prefix.

Initially, the MNN 320 communicates with the CN 300 while moving with the MR 318. When the MR 318 undergoes a handover from R1 314 to R2 316, the MNN 320 receives a zero lifetime setting for the old prefix (3ffa::/64) and immediately receives a new prefix (4ffa::/64).

Since the MNN 320 undergoes no handover at the link-level, FMIPv6 is not triggered for MNN 320. Hence all packets destined to MNN's previous CoA (3ffa::3) are lost during the handover.

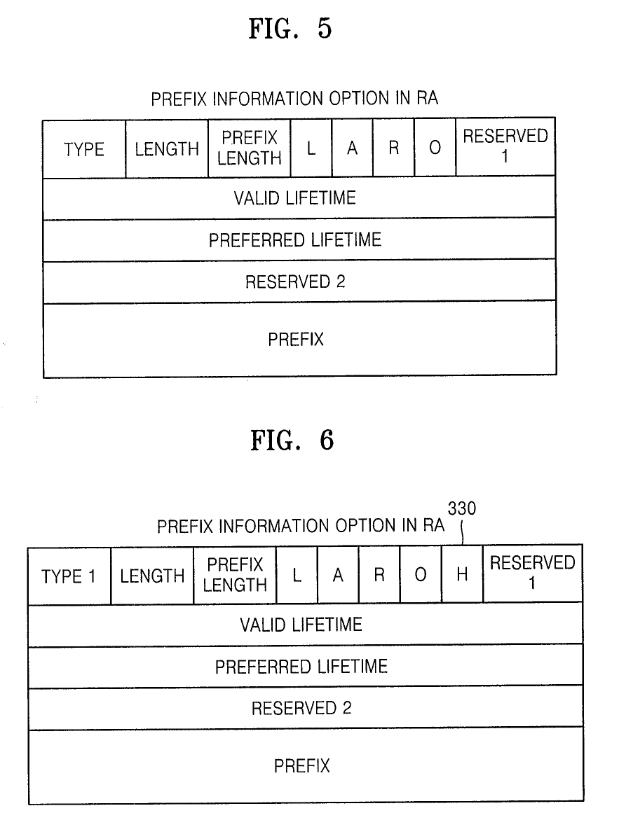

FIG. 5 shows a typical Prefix Option in a Router Advertisement (RA) message. Referring to FIG. 5, ‘L’ flag represents Onlink Flag, ‘A’ flag represents Autonomous Address Configuration Flag, ‘R’ flag indicates, when set as part of route optimization, that the Prefix field contains a complete IP address assigned to the sending router, and ‘O’ flag indicates, when set, that the prefix may be used for route optimization of mobile nodes, which are either local mobile nodes or visiting mobile nodes within the mobile network.

Valid Lifetime as shown in FIG. 5 is the length of time in seconds (relative to the time the packet is sent) that the prefix is valid for the purpose of on-link determination. Furthermore in FIG. 5, Preferred Lifetime represents the length of time in seconds (relative to the time the packet is sent) that addresses generated from the prefix via stateless address auto configuration remain preferred. Prefix represents an IP address or a prefix of an IP address. Prefix Length indicates the number of valid leading bits in the prefix.

According to aspects of the present invention, the ‘O’ flag is included as part of route optimization using ND-Proxy. The ‘O’ flag signifies that the corresponding prefix has been delegated by the MR 318, and the MNNs 320 should use this prefix for route optimization.

FIG. 6 shows a proposed Prefix Option including a new ‘H’ flag 330 according to an embodiment of the present invention. Here ‘H’ signifies handover of the MR. When the MNNs 320 receive this flag 330, the flag 330 indicates that the corresponding prefix is the one obtained by the MR 318 from PrRtAdv, and FMIPv6 can be triggered (i.e., the MNNs 320 can immediately form their new prospective CoA's and send FBUs). As shown, the flag 330 is between Flag O and Reserved 1, but aspects of the present invention are not limited thereto.

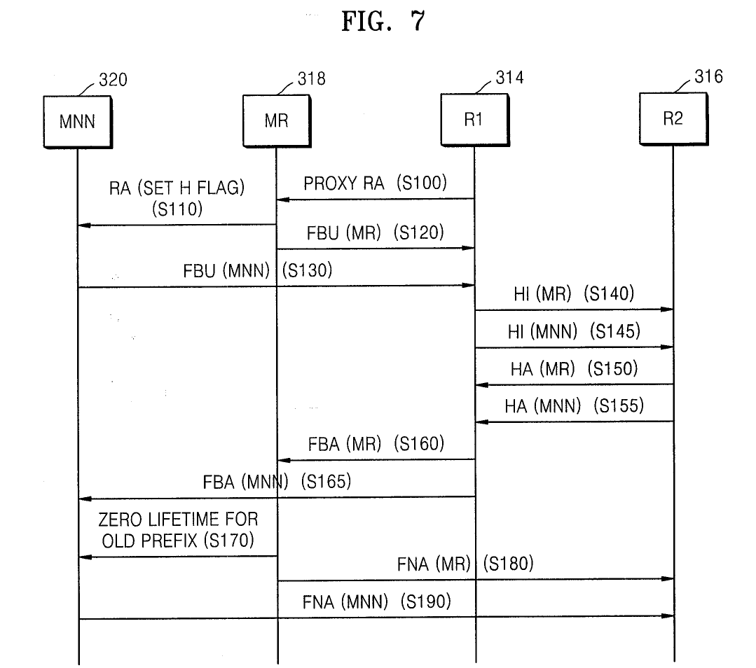

FIG. 7 is a timing diagram of a method of applying FMIPv6 according to an embodiment of the present invention. Specifically, FIG. 7 depicts control and data message flow, including identifying when exactly the Prefix Option with the ‘H’ flag is sent, when the MNNs 320 should trigger FMIPv6, and when the zero lifetime setting for the old prefix is to be sent. It is assumed that the MR 318, the MNN's 320 and the Access Routers (R1 314 and R2 316) are capable of FMIPv6. Furthermore, the MNN 320 includes a visiting mobile node (VMN).

Referring to FIG. 7, the MR 318 receives a Proxy RA (PrRtAdv) from R1 314 (with R2's prefix 4ffa::/64) in operation S100. The MR 318 sends an RA to the MNNs 320 with the ‘H’ flag set for the prefix 4ffa::/64 in operation S110, and sends an FBU to R1 314 in operation S120. The MNN 320 receives the new prefix in the received RA, and sends the FBU to R1 314 through the MR 318 in operation S130. As in FMIPv6, R1 314 and R2 316 exchange Handover Initiate (HI) and Hack messages for the MR 318 and the MNN's 320 prospective new CoAs in operations S140, S145, S150, and S155. In response, the R1 314 sends corresponding Fast Binding Acknowledgements (FBAck) to the MR 318 and the MNN 320, respectively, in operations S160 and S165. The MR 318 receives the respective FBAck (operation S160) and the MNN 320 receives the respective FBAck (operation S165). The MR 318 undergoes handover and sends a zero lifetime setting for the old prefix 3ffa::/64 to the MNN 320 in operation S170, and sends a Fast Neighbor Advertisement (FNA) to R2 316 in operation S180. The MNN 320 receives a zero lifetime setting for the old prefix 3ffa::/64 and sends an FNA to R2 316 through the MR 318 in operation S190.

The MR 318 and the MNN 320 start delivering packets using their respective new CoAs (derived from the prefix 4ffa::/64). Any packets destined to the MR's 318 or the MNN's 320 old CoAs (derived from 3ffa::/64) are tunneled by R1 314 to their new CoAs, respectively.

According to aspects of the present invention, the MR acts as an ND proxy to provide route optimization for an MN. Moreover, route optimization according to aspects of the present invention prevents a loss of packets for on-going sessions performed between an MN and a CN when a corresponding MR undergoes a handover, and further reduces a delay in a handover for the MN. Furthermore, aspects of the present invention do not require resetting or support from v6 routers. Accordingly, aspects of the present invention provide a route optimization method that is easy to implement and requires very minimal implementation changes to existing equipments.

The above-presented description is of the best mode contemplated for carrying out aspects of the present invention. The manner and process of making and using it is in such a full, clear, concise and exact terms as to enable to any person skilled in the art to which it pertains to make and use this invention. New embodiments in particular, which also lie within the scope of the invention can be created, in which different details of the different examples can in a purposeful way be combined with one another.

Aspects of the present invention are, however, susceptible to modifications and alternate constructions from that disclosed above which are fully equivalent. Consequently, it is not the intention to limit aspects of the present invention to the particular embodiment disclosed. On the contrary, the intention is to cover all modifications and alternate constructions coming within the spirit and scope of aspects of the present invention as generally expressed by the following claims which particularly point out and distinctly claim the subject matter of the invention.

Aspects of the present invention can be embodied as computer-readable code in a computer-readable medium (the computer may be any device having the information processing capability). The computer-readable medium may be any recording apparatus capable of storing data that is read by a computer system (e.g., a read-only memory (ROM), a random access memory (RAM), a compact disc (CD)-ROM, a magnetic tape, a floppy disk, an optical data storage device, etc.). The computer-readable medium can be distributed among computer systems that are interconnected through a network, and aspects of the present invention may be stored and implemented as computer-readable code in the distributed system. Also, aspects of the present invention may be implemented in a carrier wave that transmits data via the Internet, for example.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of applying fast mobile IPv6 (FMIPv6) to a mobile node in a mobile network when a mobile router of the mobile network performs a handover from a first access router to a second access router, the method comprising:
receiving, at the mobile router, a message from the first access router including a prefix corresponding to the second access router;
transmitting, from the mobile router to the mobile node, a message including the received prefix corresponding to the second access router and information indicating that the prefix is received from the first access router;
transmitting, from the mobile router to the first access router, a message for FMIPv6;
transmitting, from the mobile node to the first access router, a message for FMIPv6 when the mobile node receives the message including the information indicating that the prefix is received from the first access router; and
transmitting, from the mobile router to the mobile node after the handover, a message to set a zero lifetime for a prefix corresponding to the first access router.

2. The method of claim 1, wherein the message, received by the mobile router from the first access router, including the prefix corresponding to the second access router is included in a proxy router advertisement (PrRtAdv).

3. The method of claim 1, wherein the message, transmitted from the mobile router to the mobile node, including the prefix corresponding to the second access router is included in a router advertisement (RA).

4. The method of claim 3, wherein the RA comprises an H flag indicating whether the prefix corresponding to the second access router is received from the first access router.

5. The method of claim 1, wherein the message for FMIPv6 transmitted from the mobile router and/or the message for FMIPv6 transmitted from the mobile node is a fast binding update message.

6. The method of claim 1, wherein the transmitting, from the mobile node to the first access router, of the message for FMIPv6 comprises transmitting the message for FMIPv6 before performing the handover.

7. The method of claim 4, wherein the transmitting, from the mobile node to the first access router, of the message for FMIPv6 comprises:
determining whether the H flag in the RA received from the mobile router is set to indicate that the prefix corresponding to the second access router is received from the first access router;
generating an IPv6 care of address (COA) from the prefix included in the RA if the H flag is set to indicate that the prefix corresponding to the second access router is received from the first access router; and
transmitting a binding update message to bind the CoA to the first access router.

8. The method of claim 1, wherein the handover is performed from the first access router to the second access router when the mobile router transmits the message for FMIPv6 to the first access router.

9. The method of claim 1, further comprising:
transmitting, from the mobile router to the second access router, a fast neighbor advertisement message; and
transmitting, from the mobile node to the second access router via the mobile router, a fast neighbor advertisement message.

10. The method of claim 1, further comprising the mobile router acting as a neighbor discovery (ND) proxy to provide route optimization for the mobile node.

11. A mobile router of a mobile network in which fast mobile IPv6 (FMIPv6) is applied to a mobile node when the mobile router performs a handover from a first access router to a second access router, the mobile router comprising:
a message receiving unit to receive, from the first access router, a message including a prefix corresponding to the second access router; and
a message transmitting unit to transmit a message, to the mobile node, including the prefix corresponding to the second access router and information indicating that the prefix is received from the first access router, a message, to the first access router, for FMIPv6, and a message, to the mobile node after the handover, to set a zero lifetime for a prefix corresponding to the first access router,
wherein the mobile node transmits a message for FMIPv6 to the first access router when the mobile node receives the message including the information indicating that the prefix is received from the first access router.

12. A mobile network in which fast mobile IPv6 (FMIPv6) is applied to a mobile node, the mobile network comprising:
a mobile router to perform a handover from a first access router to a second access router, to receive, from the first access router, a message including a prefix corresponding to the second access router, to transmit, to the mobile node, a message including a prefix corresponding to the second access router and information indicating that the prefix is received from the first access router, to transmit, to the first access router, a message for FMIPv6, and to transmit, to the mobile node after the handover, a message to set a zero lifetime for a prefix corresponding to the first access router; and
the mobile node to transmit, to the first access router, a message for FMIPv6 when the mobile node receives the message including the information indicating that the prefix is received from the first access router.

13. At least one computer-readable medium having recorded thereon a computer program or programs for a method of applying fast mobile IPv6 (FMIPv6) to a mobile node in a mobile network when a mobile router of the mobile network performs a handover from a first access router to a second access router implemented by one or more computers, the method comprising:
receiving, at the mobile router, a message from the first access router including a prefix corresponding to the second access router;
transmitting, from the mobile router to the mobile node, a message including the received prefix corresponding to the second access router and information indicating that the prefix is received from the first access router;
transmitting, from the mobile router to the first access router, a message for FMIPv6;
transmitting, from the mobile node to the first access router, a message for FMIPv6 when the mobile node receives the message including the information indicating that the prefix is received from the first access router; and
transmitting, from the mobile router to the mobile node after the handover, a message to set a zero lifetime for a prefix corresponding to the first access router.

14. The method as claimed in claim 5, further comprising:
transmitting, from the first access router to the mobile router, a fast binding acknowledgement message after the first access router receives the fast binding update message from the mobile router; and
transmitting, from the first access router to the mobile node, a fast binding acknowledgement message after the first access router receives the fast binding update message from the mobile router.

15. A mobile node applying fast mobile IPv6 (FMIPv6) in a mobile network when a mobile router of the mobile network performs a handover from a first access router to a second access router, the mobile node comprising:
a message receiving unit to receive a message including a prefix corresponding to the second access router and information indicating that the prefix is received from the first access router; and
a message transmitting unit to transmit a message for FMIPv6 to the first access router when the mobile node receives the message indicating that the prefix is received from the first access router,
wherein the mobile router receives, from the first access router, a message including the prefix corresponding to the second access router, transmits, to the mobile node, the message including the prefix corresponding to the second access router and information indicating that the prefix is received from the first access router, transmits, to the first access router, a message for FMIPv6, and transmits to the mobile node after the handover a message to set a zero lifetime for a prefix corresponding to the first access router.

16. A method of applying fast mobile IPv6 (FMIPv6) to a mobile node in a mobile network when a mobile router of the mobile network performs a handover from a first access router to a second access router, the method comprising:
receiving, at the mobile router, a message from the first access router including a prefix corresponding to the second access router;
transmitting, from the mobile router to the mobile node, a message including the received prefix corresponding to the second access router and an indication that FMIPv6 can be performed;
transmitting, from the mobile router to the first access router, a message for FMIPv6; and
transmitting, from the mobile node to the first access router, a message for FMIPv6 when the mobile node receives the message including the indication that FMIPv6 can be performed.

17. The method as claimed in claim 16, further comprising:
transmitting, from the mobile router to the mobile node after the handover, a message to set a zero lifetime for a prefix corresponding to the first access router.

18. The method as claimed in claim 16, wherein the indication that FMIPv6 can be performed is information indicating that the prefix is received from the first access router.

19. A method of a mobile node applying fast mobile IPv6 (FMIPv6) in a mobile network when a mobile router of the mobile network performs a handover from a first access router to a second access router, the method comprising:
receiving, from the mobile router, a message including a prefix corresponding to the second access router and information indicating that the prefix is received from the first access router;
transmitting, to the first access router, a message for FMIPv6 after receiving the message including the information indicating that the prefix is received from the first access router; and
receiving, from the mobile router after the handover, a message to set a zero lifetime for a prefix corresponding to the first access router.

20. A method of a mobile router of a mobile network applying fast mobile IPv6 (FMIPv6) to a mobile node in the mobile network when the mobile router performs a handover from a first access router to a second access router, the method comprising:
receiving a message from the first access router including a prefix corresponding to the second access router;
transmitting, to the mobile node, a message including the received prefix corresponding to the second access router and information indicating that the prefix is received from the first access router;
transmitting, to the first access router, a message for FMIPv6; and
transmitting, to the mobile node after the handover, a message to set a zero lifetime for a prefix corresponding to the first access router.
